(19) United States
(12) Patent Application Publication
(10) Pub. No.: US 2012/0308200 A1
(43) Pub. Date: Dec. 6, 2012

(54) CONTIGUOUS MEDIA PLAYBACK

(75) Inventors: Lisa Seacat DeLuca, San Francisco, CA (US); Charles Marcel Kinard, Cary, NC (US)

(73) Assignee: INTERNATIONAL BUSINESS MACHINES CORPORATION, Armonk, NY (US)

(21) Appl. No.: 13/150,344

(22) Filed: Jun. 1, 2011

(51) Int. Cl. H04N 9/80

(52) U.S. Cl. 386/241; 386/E05.003

(57) ABSTRACT

In one embodiment of the invention, a method for contiguous media playback comprises recording a first media content and storing the recorded first media content in a first media file; recording a second media content and storing the recorded second media content in a second media file; playing the first media file; determining if the second media content was recorded within a predefined window of and from a same channel as the recording of the first media content; determining a user preference for contiguous playback; and if the second media content was recorded within a predefined window of and from a same channel as the recording of the first media content and if the user preference is for contiguous playback, playing the second media file contiguous with the first media file.

### BACKGROUND

The present invention relates to the field of recording and playback of media.

Personal entertainment content, such as television programs, is becoming more plentiful and accessible. Digital video recorders (DVRs) or other similar recording devices enable users to identify and record programs for later viewing and enjoyment.

Today when a user records a program (call it Program A), the DVR stops recording after the duration of the program. If another program (call it program B) airs immediately following program A and is also set to record, a new recording segment is set. This allows the DVR the ability to chunk programs making it easier for users to sort programs within their DVR menu and watch the program in any order they prefer. However, if a user tends to watch Program B after Program A, today the user would need to perform four steps (exit program A, access the main DVR menu, find program B, and select to play program B) to watch Program A after watching Program B.

Further, a DVR user may be concerned about not missing any part of a program due to slight variabilities in the broadcast time. For example, a previous program on that channel may have run ten minutes long and shifted all subsequent programs that day to start and end ten minutes late. To address this potential problem, users often add additional time to the beginning and ending points of the record time. For example, a program that normally runs from 7:00-8:00 may be set to record from 6:50 to 8:10. If two such programs are set to record back-to-back on the same channel, there will be overlap. Handling the overlap typically requires use of a second tuner, which causes the same channel to be recorded by two tuners for the duration of the overlap.

### BRIEF SUMMARY

In one embodiment of the invention, a method for contiguous media playback comprises recording a first media content and storing the recorded first media content in a first media file; recording a second media content and storing the recorded second media content in a second media file; playing the first media file; determining if the second media content was recorded within a predefined window of and from a same channel as the recording of the first media content; determining a user preference for contiguous playback; and if the second media content was recorded within a predefined window of and from a same channel as the recording of the first media content and if the user preference is for contiguous playback, playing the second media file contiguous with the first media file.

In addition to the method for contiguous media playback, as described above, other aspects of the present invention are directed to corresponding systems and computer program products for contiguous media playback.

In addition to the method, system, and computer program product for contiguous media playback, other aspects of the present invention are directed to corresponding methods, systems, and computer program products for contiguous media recording.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a network in which embodiments of the invention may operate;

FIG. 2 is a schematic block diagram of a media recording device, such as a digital video recorder (DVR), of the network of FIG. 1;

FIG. 3 illustrates a recording schedule for a media recording device, in accordance with an embodiment of the present invention; and

FIG. 4 illustrates a recording schedule for a media recording device that has been modified in accordance with an embodiment of the present invention.

### DETAILED DESCRIPTION

Embodiments of the invention may provide the ability to contiguously playback two or more items of recorded media content while skipping over overlapping portions of the content.

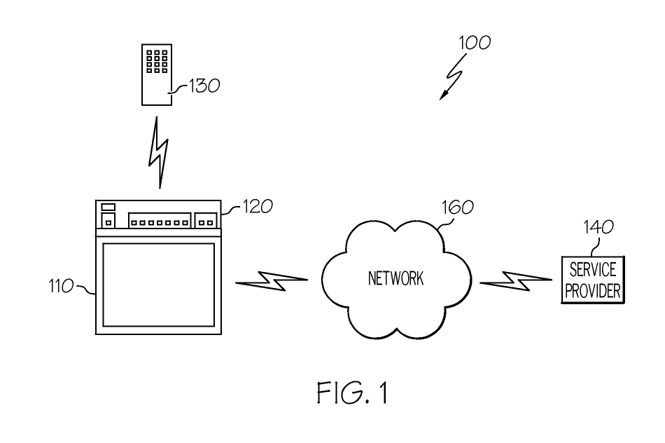

FIG. 1 is a block diagram of a system 100 in which embodiments of the invention may be implemented. As illustrated, system 100 may include a television (TV) 110, a media recording device 120 (such as a digital video recorder (DVR)), a remote control 130, and a service provider 140 (e.g., a server) interconnected by a network 160. Components of system 100 may interconnect via wired and/or wireless connections. For simplicity, a single television 110, DVR 120, remote control 130, service provider 140, and network 160 have been illustrated in FIG. 1. In practice, there may be more televisions 110, DVRs 120, remote controls 130, service providers 140, and/or networks 160. Also, in some instances, one or more of the components of system 100 may perform one or more functions described as being performed by another one or more of the components of system 100. For example, television 110 may include components and functionality typically associated with DVR 120.

Television 110 may comprise any suitable display device capable of displaying television programming, content provided by DVR 120, and/or content provided by other devices (e.g., a digital video disk (DVD) player, a video camera, a home media player, etc., not shown) connected to television 110. Alternatively, television 110 may take the form of a computer (desktop computer, laptop computer, tablet computer, or the like), smartphone, PDA, a mobile phone, or any device with a display for viewing content.

DVR 120 may comprise any device or combination of devices that receives television programming (e.g., from service provider 140), selectively records the received programming video in a digital format to a disk drive or other memory associated with DVR 120, and provides the television programming (e.g., live or recorded) to television 110 or another device. In some implementations, DVR 120 may record the received programming to a remote storage location via, e.g., network 160 that is located within the customer premises or outside of the customer premises. For example, DVR 120 may record the received programming to a storage device separate from DVR 120, such as a network attached storage (NAS) device, an external serial ATA (eSATA) device, a remote storage (RS) server device, a networked computer, a networked DVR, etc. DVR 120 may allow a user to alter the programming provided to television 110 and/or scheduled for recording based on a signal from remote control 130. In one implementation, features of DVR 120 (e.g., a hard disk drive, scheduling components, etc.) may be incorporated directly within television 110.

Remote control 130 may comprise a device that allows a user to control functionality associated with DVR 120 and/or television 110. For example, remote control 130 may facilitate user control of programming and/or content displayed on television 110 via interaction with DVR 120. Furthermore, remote control 130 may enable interaction with the scheduling described in additional detail below.

Service provider 140 may include one or more server entities, or other types of computation or communication devices, that gather, process, search, and/or provide information in a manner described herein. In one implementation, service provider 140 may include a server (e.g., a computer system or an application), a cable head-end, or a broadcaster capable of providing content (e.g., TV programming, movies, on-demand services, live television, news feeds, blog feeds, advertisements, instructions, codes, encryption keys, and/or other information associated with products and/or services, etc.), to DVR 120.

Network 160 may include a local area network (LAN), a wide area network (WAN), a telephone network, such as the Public Switched Telephone Network (PSTN), a cable television network, an intranet, the Internet, an optical fiber (or fiber optic) network, or a combination of networks.

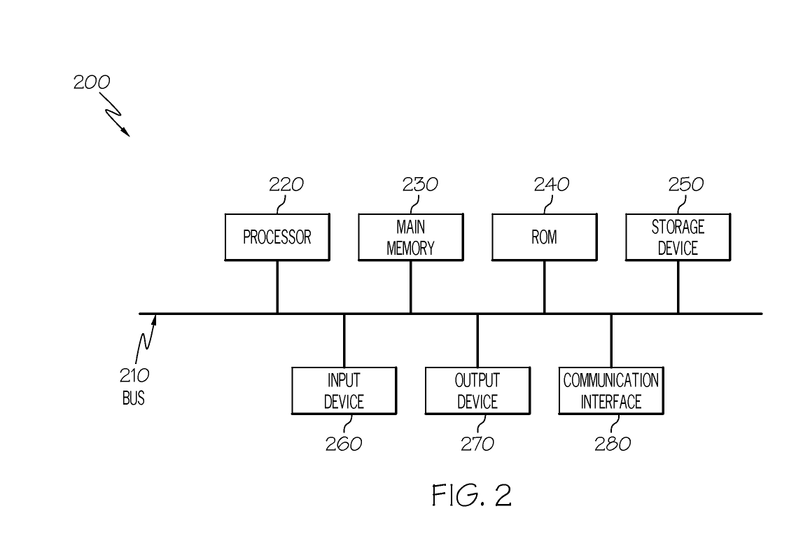

FIG. 2 is a diagram of one possible internal structure of a device 200 that may correspond to DVR 120 of FIG. 1. As illustrated, device 200 may comprise a bus 210, processor 220, a main memory 230, a read-only memory (ROM) 240, a storage device 250, an input device 260, an output device 270, and/or a communication interface 280. Device 200 may comprise many more components that, for simplicity, are not illustrated. Bus 210 is essentially a shared conduit that connects different elements (e.g., processor, disk storage, memory, input/output ports, network ports, etc.) of a device (such as a computer or other processor-based device) that enables the transfer of information between the elements.

Processor 220 may be comprised of a microprocessor, dedicated or general purpose circuitry (such as an application-specific integrated circuit or a field-programmable gate array), a suitably programmed computing device, or any other suitable means that may interpret and execute instructions for controlling the operation of the device.

Main memory 230 may include a random access memory (RAM) or another type of dynamic storage device that may store information and instructions for execution by processor 220. ROM 240 may include a ROM device or another type of static storage device that may store static information and/or instructions for use by processor 220. Storage device 250 may include a magnetic and/or optical recording medium and its corresponding drive. In one implementation storage device 250 may be configured to store television programming received by DVR 120.

Input device 260 may include a mechanism that permits an operator to input information to device 200, such as a keyboard, a mouse, a pen, a microphone, voice recognition mechanisms, a remote control (e.g., remote control 130), etc. Output device 270 may include a mechanism that outputs information to the operator, including a display, a printer, a speaker, etc. Communication interface 280 may include any transceiver-like mechanism that enables device 200 to communicate with other devices and/or systems. For example, communication interface 280 may include mechanisms for communicating with another device or system via a network, such as network 160.

As described herein, device 200 may perform certain operations in response to processor 220 executing software instructions contained in a computer-readable medium, such as main memory 230. A computer-readable medium may include a physical or logical memory device. The software instructions may be read into main memory 230 from another computer-readable medium, such as storage device 250, or from another device via communication interface 280. The software instructions contained in main memory 230 may cause processor 220 to perform processes described herein. Hardwired circuitry may be used in place of or in combination with software instructions to implement processes described herein. Thus, implementations described herein are not limited to any specific combination of hardware circuitry and/or software.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

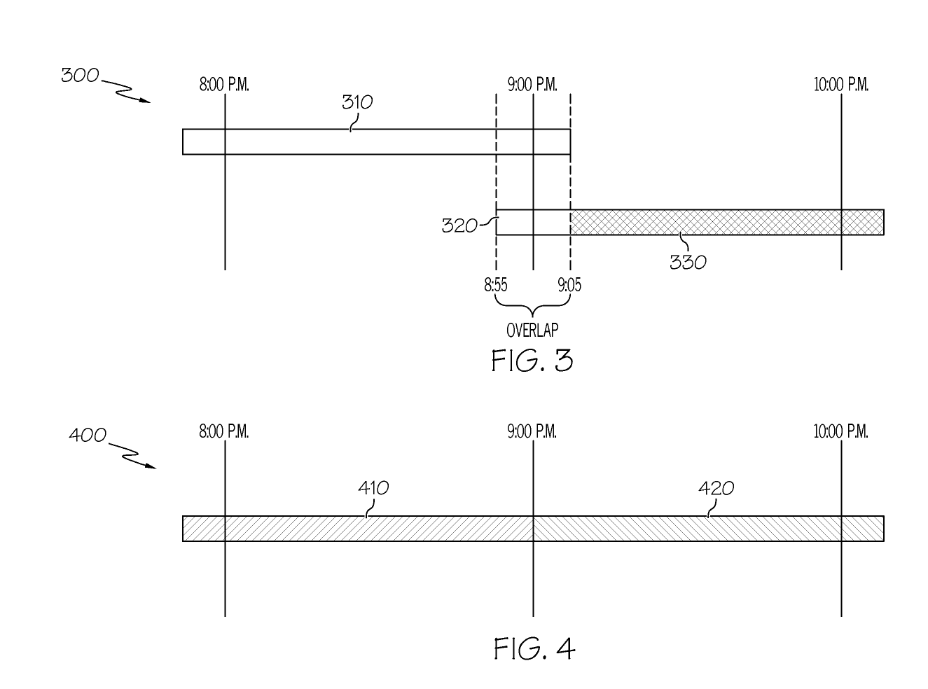

Referring now to FIG. 3, a recording schedule for a media recording device is illustrated in accordance with an embodiment of the present invention. The schedule 300 of FIG. 3 is an example of a typical schedule which may be set by a user of a DVR. The schedule 300 shows that two programs (Program 310 and Program 320) are set to record at different, but overlapping times. Although not illustrated in FIG. 3, the two programs in schedule 300 are both to be recorded on the same channel. Program 310 is scheduled by the broadcaster to broadcast from 8:00 PM to 9:00 PM and Program 320 is scheduled by the broadcaster to broadcast from 9:00 PM to 10:00 PM.

In the illustrated example, the user has set the DVR to record Program 310 and Program 320. This example assumes that the user also tends to watch the two programs in the order in which they were recorded. Because the user likes both programs so much, the user adds time to the beginning and end of both recordings in the off chance that the recordings start early or run over (such as, for example, because the program preceding Program 310 ends later than scheduled). This is seen in FIG. 3, in which the scheduled recording of Program 310 goes from 7:55 PM to 9:05 PM and the scheduled recording of Program 320 goes from 8:55 PM to 10:05 PM. This results in a ten minute overlap (from 8:55 PM to 9:05 PM) in which the same content is being recorded two times. This resulting ten minute overlap assumes that there are two tuners available to record from. If there is only one tuner to record from, then one of the programs (either 310 or 320) will be missing ten minutes of content, because the tuner was yielded to record the other program during the overlap period.

Assume in this example that the user begins watching Program 310. When Program 310 has ended over, there is five minutes of Program 320 recorded on the same recording. Because the user typically watches Program 320 after watching Program 310, the user does not stop the current recording but rather continues to watch and watches the first five minutes of Program 320 captured in the recording of Program 310.

Without embodiments of the invention, the first recording will end after the first five minutes of Program 320 have been watched. The user will typically see and/or hear a prompt from the DVR to either keep or delete the first recording. Assuming the user does not desire to keep this recording and desires to continue to watch the remaining fifty-five minutes of Program 320, the user responds to the prompt and deletes the first recording. The user must then return to the DVR menu, find Program 320 (making sure to select the oldest in the queue of other episodes of Program 320 (if there is a queue, because for example the user has neglected to watch the program for several weeks)), and instruct the DVR to play the second recording. Now the user fast forwards ten minutes into the second recording (past the last five minutes of Program 310 and the first five minutes of Program 320) as the user already watched those ten minutes of content.

In contrast, embodiments of the invention may enable Program 320 to begin playing immediately after Program 310 has ended. Program 320 may begin playing without any notice or prompt for the user, or the user may be prompted to confirm that the user desires Program 320 to begin playing. A user preference for always playing back the next contiguous program may be predetermined and stored in a profile in the DVR, and the DVR may be configured to check this user preference in the profile to determine whether to automatically begin playing the next contiguous program. Embodiments of the invention may be able to determine that the overlap exists between the first and second recordings and that the user has already watched the first five minutes of Program 320. Accordingly, embodiments of the invention may begin playing the second recording at the 9:05 PM mark, such that the user does not have to fast forward the second recording in order to avoid watching a portion of Program 320 a second time. The portion of Program 320 that is played is illustrated by the hatching 330 in FIG. 3.

In one possible implementation of embodiments of the invention, a user will set the user's DVR to record programs. As the programs record, additional meta-data about the preceding and following programs may be saved with the recording. Additionally, the recorded content may be time stamped. After the user has finished watching Program A, the DVR may check the meta-data for Program A to determine if the user has a recording for the following program, program B. If the user has a recording saved for Program B, the DVR could take any one of several possible optional actions. The DVR could prompt the user to determine if the user desires to delete or save the recording of Program A. The DVR could prompt the user to determine if the user desires to have Program B begin playing (with or without taking any action on the recording of Program A). The DVR could simply begin playing Program B without providing any prompt to the user (such an option may be taken based on a previously determined and stored user preference).

If the DVR plays Program B (either automatically or in response to a user selection), the DVR is capable of determining if Program A overlaps with Program B and playing Program B's recording beginning where program A's recording left off. If the user does not have a recording saved for Program B, regular program termination occurs after Program A finishes playing.

As mentioned above, the DVR could prompt the user to determine if the user desires to delete or save the recording of Program A after Program A finishes playing. Alternatively, the DVR could queue up and play program B and wait until program B is over to prompt for the user to perform an action (e.g., save or delete) on the recording of Program A, on the recording of Program B, or on both recordings.

Using the same meta-data, embodiments of the invention could optionally prompt a user when the user attempts to play a later-recorded program (e.g., Program B) before a preceding program (e.g., Program A). While the order in which recorded programs are watched often does not matter, it is sometimes preferable to watch recorded programs only in the order in which they were recorded. For example, even if Program A and Program B are different television series, some television series may have characters and storylines that cross over to another series on the same network (often to a series broadcast later the same night). In such a situation, the user could be confused if the user watched Program B before watching Program A.

In one embodiment of the invention, Program B may be contiguously played with Program A if Program A and Program B were broadcast and recorded back-to-back on the same channel (i.e., Program A was broadcast and recorded immediately preceding Program B). In other embodiments of the invention, a window of time may be defined (such as by user selection) which may separate the broadcast and recording of two programs while still providing for the two programs to be played contiguously. For example, a user might record Program A at 8:00 PM and Program C at 10:00 PM but not Program B at 9:00 PM, but would like Programs A and C to play contiguously. To handle such a case, embodiments of the invention could enable the user to set a preference to indicate the user would like to contiguously play those programs that are broadcast and recorded within, for example, two hours of one another.

As mentioned above, if two back-to-back programs are set to record with an extended time (i.e., if the first program is set to record extra at the end and/or the second program is set to record extra at the beginning) on the same channel, there will be overlap that typically requires use of a second tuner. Alternative embodiments of the invention may be able to eliminate this overlap and therefore eliminate the need to use two tuners in such situations. This would in turn free up one of the tuners to be used to record a third program on a different channel, or not have the overlap period dropped from one of the recordings in the case there is only one tuner available. Because there are two back-to-back programs set to record on the same channel, there is no need for this overlap. If the first program runs longer than scheduled, the scheduled recording of the second program will capture the portion of the first program that runs late.

If a recording is set up by a user as illustrated in FIG. 3 (in which two back-to-back programs are set to record with an extended time on the same channel such that there is an overlap), embodiments of the invention may be capable of determining that such a recording is scheduled. Embodiments of the invention may then be capable of modifying the scheduled recording to eliminate the overlap. Referring now to FIG. 4, a modified recording schedule is illustrated in accordance with an embodiment of the present invention. Recording schedule 400 of FIG. 4 is modified from the original recording schedule illustrated in FIG. 3 to remove the overlap. As seen in FIG. 4, the scheduled recording of the first Program 410 has been modified to remove the extra five minutes at the end such that the recording ends at 9:00 PM. Similarly, the scheduled recording of the second Program 420 has been modified to remove the extra five minutes at the beginning such that the recording begins at 9:00 PM.

Which program's scheduled recording is modified may vary depending on which program is scheduled to record extra time. For example, if the first program is set to record extra at the end, then the scheduled recording of the first program may be modified to end on time (i.e., at the same time the broadcast of the program is scheduled to end). If the second program is set to record extra at the beginning, then the scheduled recording of the second program may be modified to begin on time (i.e., at the same time the broadcast of the program is scheduled to begin). If both the first and second programs are scheduled to record extra time (at the end and beginning, respectively), then both scheduled recordings may be modified. As seen in FIG. 4, any extra time scheduled to record that does not cause an overlap (e.g., the extra five minutes at the beginning of Program 410 and the extra five minutes at the end of Program 420) will typically not be affected by this feature.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. If the service is also available to applications as a REST interface, then launching applications could use a scripting language like JavaScript to access the REST interface. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method for contiguous media playback, comprising:
recording a first media content and storing the recorded first media content in a first media file;
recording a second media content and storing the recorded second media content in a second media file;
playing the first media file;
determining if the second media content was recorded within a predefined window of and from a same channel as the recording of the first media content;
determining a user preference for contiguous playback; and
if the second media content was recorded within a predefined window of and from a same channel as the recording of the first media content and if the user preference is for contiguous playback, playing the second media file contiguous with the first media file.

2. The method of claim 1, further comprising:
determining if the first media file contains a portion of the second media content and, if so, determining if the portion of the second media content contained in the first media file has been played;
wherein if the portion of the second media content contained in the first media file has been played, playing the second media file contiguous with the first media file comprises playing only a portion of the second media file not containing the portion of the second media content contained in the first media file that has been played.

3. The method of claim 1, wherein the second media content was recorded within a predefined window of the recording of the first media content if the second media content was recorded immediately subsequent to the recording of the first media content.

4. The method of claim 1, wherein the user preference for contiguous playback is determined by one of (a) querying the user after playing the first media file but before playing the second media file or (b) accessing a stored predefined user preference.

5. The method of claim 1, further comprising:
after the first and second media files have finished playing, determining whether the user desires to delete the recordings of the first media file and/or the second media file.

6. A system for contiguous media playback comprising:
a storage element; and
a processor configured for (a) recording a first media content and storing the recorded first media content in a first media file on the storage element; (b) recording a second media content and storing the recorded second media content in a second media file on the storage element; (c) playing the first media file; (d) determining if the second media content was recorded within a predefined window of and from a same channel as the recording of the first media content; (e) determining a user preference for contiguous playback; and (f) if the second media content was recorded within a predefined window of and from a same channel as the recording of the first media content and if the user preference is for contiguous playback, playing the second media file contiguous with the first media file.

7. The system of claim 6, wherein the processor is further configured for determining if the first media file contains a portion of the second media content and, if so, determining if the portion of the second media content contained in the first media file has been played; and
wherein if the portion of the second media content contained in the first media file has been played, playing the second media file contiguous with the first media file comprises playing only a portion of the second media file not containing the portion of the second media content contained in the first media file that has been played.

8. The system of claim 6, wherein the second media content was recorded within a predefined window of the recording of the first media content if the second media content was recorded immediately subsequent to the recording of the first media content.

9. The system of claim 6, wherein the user preference for contiguous playback is determined by one of (a) querying the user after playing the first media file but before playing the second media file or (b) accessing a stored predefined user preference.

10. The system of claim 6, wherein the processor is further configured for, after the first and second media files have finished playing, determining whether the user desires to delete the recordings of the first media file and/or the second media file.

11. A computer program product for contiguous media playback, the computer program product comprising a computer readable storage medium having computer readable program code embodied therewith, the computer readable program code comprising:
computer readable program code configured for recording a first media content and storing the recorded first media content in a first media file;
computer readable program code configured for recording a second media content and storing the recorded second media content in a second media file;
computer readable program code configured for playing the first media file;
computer readable program code configured for determining if the second media content was recorded within a predefined window of and from a same channel as the recording of the first media content;
computer readable program code configured for determining a user preference for contiguous playback; and
computer readable program code configured for, if the second media content was recorded within a predefined window of and from a same channel as the recording of the first media content and if the user preference is for contiguous playback, playing the second media file contiguous with the first media file.

12. The computer program product of claim 11, further comprising:
computer readable program code configured for determining if the first media file contains a portion of the second media content and, if so, determining if the portion of the second media content contained in the first media file has been played;
wherein if the portion of the second media content contained in the first media file has been played, playing the second media file contiguous with the first media file comprises playing only a portion of the second media file not containing the portion of the second media content contained in the first media file that has been played.

13. The computer program product of claim 11, wherein the second media content was recorded within a predefined window of the recording of the first media content if the second media content was recorded immediately subsequent to the recording of the first media content.

14. The computer program product of claim 11, wherein the user preference for contiguous playback is determined by one of (a) querying the user after playing the first media file but before playing the second media file or (b) accessing a stored predefined user preference.

15. The computer program product of claim 11, further comprising:
computer readable program code configured for, after the first and second media files have finished playing, determining whether the user desires to delete the recordings of the first media file and/or the second media file.

16. A method for contiguous media recording, comprising:
determining if a scheduled recording of a second media content overlaps in time a scheduled recording of a first media content on a same channel; and
if the scheduled recording of the second media content overlaps in time the scheduled recording of the first media content on the same channel, modifying the scheduled recording of the first media content and/or the scheduled recording of the second media content such that the scheduled recording of the second media content does not overlap in time the scheduled recording of the first media content.

17. A system for contiguous media recording, comprising:
a processor configured for (a) determining if a scheduled recording of a second media content overlaps in time a scheduled recording of a first media content on a same channel; and (b) if the scheduled recording of the second media content overlaps in time the scheduled recording of the first media content on the same channel, modifying the scheduled recording of the first media content and/or the scheduled recording of the second media content such that the scheduled recording of the second media content does not overlap in time the scheduled recording of the first media content.

18. A computer program product for contiguous media recording, the computer program product comprising a computer readable storage medium having computer readable program code embodied therewith, the computer readable program code comprising:
computer readable program code configured for determining if a scheduled recording of a second media content overlaps in time a scheduled recording of a first media content on a same channel; and
computer readable program code configured for, if the scheduled recording of the second media content overlaps in time the scheduled recording of the first media content on the same channel, modifying the scheduled recording of the first media content and/or the scheduled recording of the second media content such that the scheduled recording of the second media content does not overlap in time the scheduled recording of the first media content.
